(19) United States
(12) Patent Application Publication
(10) Pub. No.: US 2005/0156565 A1
(43) Pub. Date: Jul. 21, 2005

(54) Battery with a built-in charging circuit

(76) Inventor: Lien-Sheng Chien, Taoyuan City (TW)

Correspondence Address: RABIN & Berdo, PC, 1101 14TH STREET, NW, SUITE 500, WASHINGTON, DC, 20005, US

(21) Appl. No.: 11/038,172

(22) Filed: Jan. 21, 2005

(30) Foreign Application Priority Data
Jan. 20, 2004 (TW) 93101684

(51) Int. Cl. H02J 7/02

(52) U.S. Cl. 320/112

(57) ABSTRACT

A battery includes the following elements: a battery cell for storing electrical energy, a housing for covering the battery, and a control circuit for controlling the battery. A socket is formed on the housing. The control circuit includes a charging circuit electrically connected the socket to the battery cell. While the socket is electrically connected to a power supply, the battery cell is charged through the charging circuit.

This application claims the benefit of Taiwan application Serial No. 93101684, filed Jan. 20, 2004, the subject matter of which is incorporated herein by reference.

### BACKGROUND OF THE INVENTION

1. Field of the Invention

The invention relates in general to a battery, and more particularly to a battery with a built-in charging circuit.

2. Description of the Related Art

Cellular phones have become popular communication equipments for modern people in daily life because its movability and convenience. In order to makes a cellular phone working, it is necessary to provide a battery as it electricity source, and when the electricity is exhausted from the battery, the battery has to be charged by a battery charger to restore electricity.

There are two kinds of chargers seen in the market, one of which is a travel charger. The travel charger charges a battery through the charging circuit built in the phone main body. However, this kind of processing way may damage the charging circuit inside of the phone main body, especially the battery is charged by the low quality travel charger.

The other charger available in the market is a battery charger set which includes a charging circuit itself. The battery charger set charges the battery through the charging circuit built in the battery charger set. Although using a battery charger set won't damage the phone main body like a travel charger does, the battery charger set is inconvenient to carry owing to its bigger size and greater weigh compared to a travel charger. Also, a battery charger set is not one of the standard accessories of a cellular phone, so that if customers want to have a battery charger set, they have to pay additional cost.

In summary, either using the charging circuit of a battery charger set or using the charging circuit inside of the cellular phone main body, there are still some problems needed to be resolved. Therefore, it is necessary to be researched that how to make the processing way of charging a battery more convenient and more safe.

### SUMMARY OF THE INVENTION

It is therefore an object of the invention to provide a battery with a built-in charging circuit. The battery can be charged by merely electrically connecting a socket on the housing of the battery to a power supply. Therefore, the present invention provides the advantages of ease in use, protection of cellular phone, and less cost to users.

The invention achieves the above-identified object by providing a battery includes a battery cell, a housing and a control circuit. The battery cell is for storing electrical energy. The housing is for covering the battery cell and there is a socket formed thereon. The control circuit is for controlling the battery, and the control circuit includes a charging circuit electrically connected to the socket and the battery cell. Therefore, while the socket is electrically connected to a power supply, the battery cell is charged through the charging circuit.

It is another object of the invention to provide a battery includes an exposing face, a conjunction face, an terminal, and a socket. While the battery is installed in a main body of an electrical device, the exposing face is exposed and the conjunction face are covered by the electrical device. The terminal is disposed on the conjunction face. The socket is disposed on the exposing face. While the battery is installed in the electrical device, the terminal is electrically connected to the electrical device, and the socket is electrically connected to a power supply.

It is another object of the invention to provide an electrical device includes a main body and a battery installed to the main body. The battery includes a battery cell, a housing and a control circuit. The battery cell is for storing electrical energy. The housing is for covering the battery cell and there is a socket formed thereon. The control circuit is for controlling the battery, and the control circuit includes a charging circuit electrically connected the socket to the battery cell. Therefore, while the socket is electrically connected to a power supply, the battery cell is charged through the charging circuit.

It is another object of the invention to provide an electrical device includes a main body and a battery installed to the main body. The battery includes an exposing face, a conjunction face, a terminal, and a socket. While the battery is installed in a main body of an electrical device, the exposing face is exposed and the conjunction face is covered by the electrical device. The terminal is disposed on the conjunction face. The socket is disposed on the exposing face. While the battery is installed in the electrical device, the terminal is electrically connected to the electrical device, and the socket is electrically connected to a power supply.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic diagram of a battery according to the first example of the preferred embodiment of the invention.

FIG. 2 is a block diagram of the control circuit of the battery according to the first example of the preferred embodiment of the invention.

FIG. 3 is a schematic diagram showing the battery installed in a cellular phone according to the first example of the preferred embodiment of the invention.

FIG. 4 is a schematic diagram showing the battery installed in a cellular phone according to the second example of the preferred embodiment of the invention.

FIG. 5A is a schematic diagram of a cellular phone according to the third example of the preferred embodiment of the invention.

FIG. 5B is a schematic diagram of another cellular phone according to the third example of the preferred embodiment of the invention.

FIG. 6 is a schematic diagram showing the battery installed in the cellular phone in FIG. 5B.

### DETAILED DESCRIPTION OF THE INVENTION

### FIRST EXAMPLE

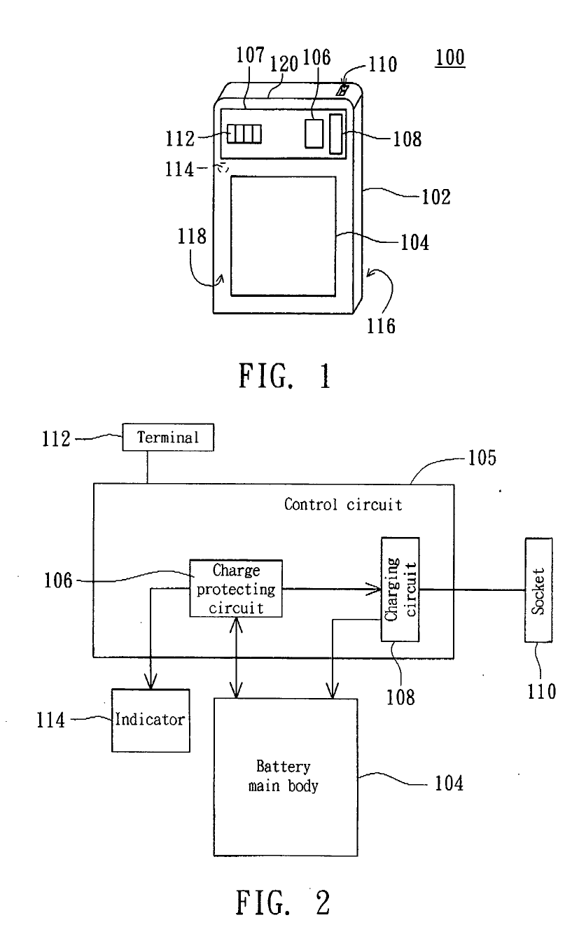

Referring to FIG. 1, it is a schematic diagram of a battery according to the first example of the preferred embodiment of the invention. The battery 100 of the present invention has an additional charging circuit and a socket for charging process, which is different from conventional batteries. The battery 100 is preferrably a 3.6V Lithium ion battery of a 3.6V Nickel-hydrogen ion battery, and the battery 100 includes a battery cell 104, a housing 102 and a control circuit 105.

The battery cell 104 is for storing electrical energy. The housing 102 is for covering the battery cell 104 and the material of the housing 102 is preferably plastic. There is a socket 110 formed on the housing 102 for being electrically connected to an external power supply (not shown in figures), and the socket 110 is preferably disposed on the bottom 120 of the housing 102.

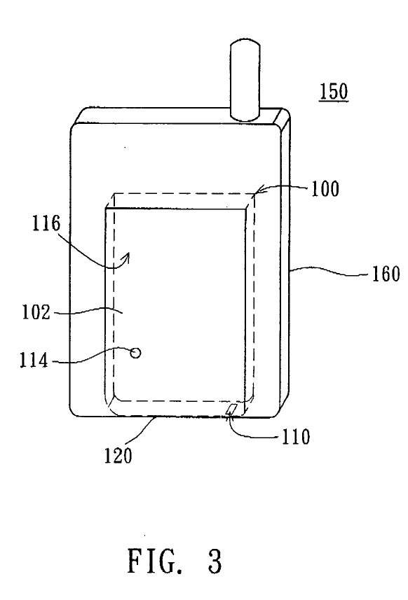

Referring both to FIG. 1 and FIG. 2, FIG. 2 is a block diagram of the control circuit of the battery according to the first example of the preferred embodiment of the invention. The control circuit 105 includes a charging circuit 108 electrically coupled the socket 110 to the battery cell 104, and the charging circuit 108 is disposed on the housing 102 of the battery. The control circuit 105 further includes a charge protecting circuit 106 electrically connected to the charging circuit 108 and the battery cell 104.

While the socket 110 is electrically connected to an external power supply, the external power supply provides electricity power to the charging circuit 108 so that the battery cell 104 can be charged through the charging circuit 108. The external power supply is preferably a travel charger, or any other equipment is also suitable as long as the equipment capable of providing electricity power to the battery.

While the battery cell 104 is charged through the charging circuit 108, the charge protecting circuit 106 will detect the electricity power stored in the battery cell 104. If the electricity stored in the battery cell 104 is full, the charge protecting circuit 106 will stop the function of the charging circuit 108 so that the battery 100 can be prevented from over-charging. As the result, the charge protecting circuit 106 can prolong the life of the battery 100.

Also, an indicator 114 is on the housing 102 of the battery 100 and the indicator 114 is electrically connected to the charge protecting circuit 106 for showing the power level. When the electricity power stored in the battery cell 104 is full, the charge protecting circuit 106 lights up the indicator 144 so that users can be notified. The indicator 114 is a light-emitting diode (LED) and is preferably disposed on the exposing face 116 of the housing 102 of the battery 100.

Further, the control circuit 105 electrically connects to several terminals and these terminals are preferably disposed on the conjunction face 118 of the housing 102 of the battery 100. For example, the battery 100 of the first example of the present invention can be installed to an electrical device in order to provide electricity power to the electrical device. In order to describe how the battery 100 be installed to the electrical device more clearly, the following description will take a cellular phone as the example.

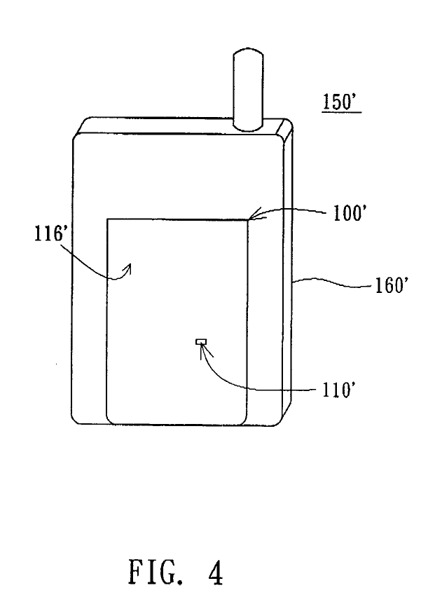

Referring both to FIG. 1 and FIG. 3, FIG. 3 is a schematic diagram showing the battery installed in a cellular phone according to the first example of the preferred embodiment. In FIG. 3, the cellular phone 150 includes a main body 160 and a battery 100 installed to the main body 160. While the battery 100 is installed in the main body 160 of the cellular phone 150, the exposing face 116 of the battery 100 is exposed out of the main body 160 of the cellular phone 150, and the conjunction face 118 of the battery 100 is covered by the main body 160 of the cellular phone 150. The terminal 112 disposed on the conjunction face 118 is electrically connected to the main body 160 of the cellular phone 150 so that the socket 110 can be electrically connected to an external power supply (not shown in figures) directly. As the result, the main body 160 of the cellular phone 150 is still charged through the charging circuit 108 inside of the battery 100 rather than through the charging circuit inside of the cellular phone 150 even though the battery 100 is installed in the main body 160 of the cellular phone 150.

### SECOND EXAMPLE

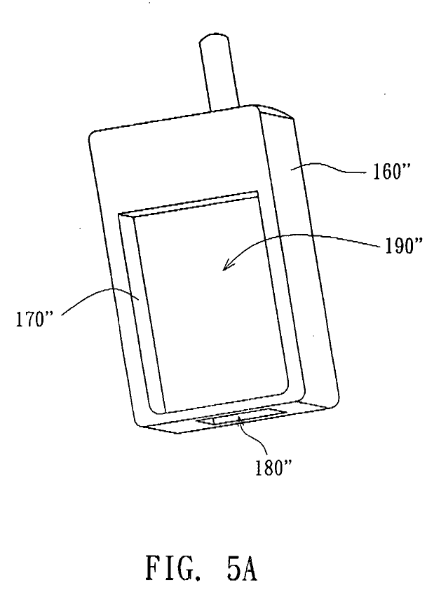

Referring to FIG. 4, it is a schematic diagram showing the battery installed in a cellular phone according to the second example of the preferred embodiment of the invention. In FIG. 4, the cellular phone 150′ includes a main body 160′ and a battery 100′ installed to the main body 160′of the cellular. The battery 100′ includes at least an exposing face 116′ and a socket 110′ disposed on the exposing face 116′. While the battery 100′ is installed in the main body 160′of the cellular, the exposing face 116′ is exposed out of the main body 160′of the cellular, and the socket 110′ can be electrically connected to an external power supply (not shown in figures) directly.

The difference between the first example and the second example is on the location of the socket. Referring to FIG. 3 again, it is clear to show that the socket 110 is disposed on the bottom 120 of the housing 102. But the socket 100′ is disposed on the exposing face 116′ of the battery 100′ in FIG. 4. Therefore, the location of the socket 110/110′ is not limited to the above example. Any locations allowing the socket to be electrically connected to an external power supply are within the scope of the invention.

### THIRD EXAMPLE

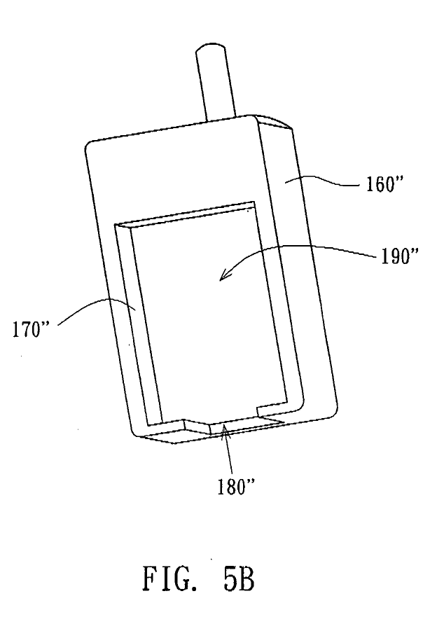

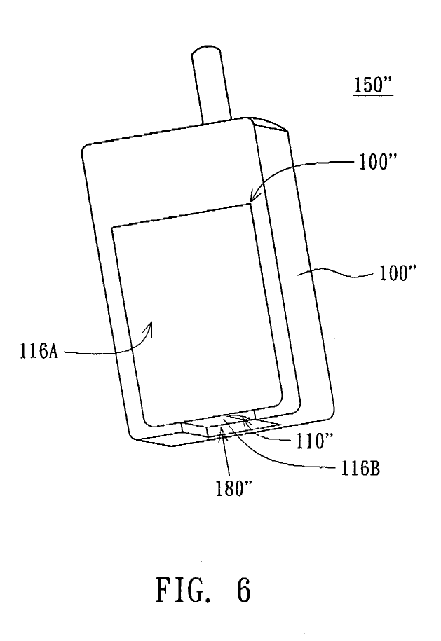

Referring to FIG. 5A, it is a schematic diagram of a cellular phone according to the third example of the preferred embodiment of the invention. The main body 160′ of the cellular has a surrounding flange 170″. The surrounding flange 170″ surrounds a receiving cavity for the battery. Also, there is an opening 180″ on the surrounding flange 170″ to allow the socket be exposed out of the opening 180″ while the battery is disposed in the receiving cavity 190″. The disposition way of the opening 180″ is not limited to the example in FIG. 5B. Next, the situation when the battery is installed to the main body of the cellular of the third example will be present in FIG. 5B, and FIG. 6.

FIG. 5B is a schematic diagram of another cellular phone according to the third example of the preferred embodiment of the invention, and FIG. 6 is a schematic diagram showing the battery installed in the cellular phone in FIG. 5B. In FIG. 6, the cellular phone 150′ includes a main body 160′ and a battery 100′ installed to the main body 160′. The battery 100′ includes at least two exposing faces 116A, 116B, and a socket 110′. The socket 110′ is disposed on the exposing faces 116B and the socket 110′ is exposed out of the opening 180″ while the battery 100″ is disposed in the receiving cavity 190″, so that the socket 110″ can be electrically connected to an external power supply (not shown in figures).

The battery of the present invention has an additional charging circuit and a socket for charging process, which is different from conventional batteries. That means the battery with a built-in charging circuit can be charged simply by electrically connecting a socket on the housing of the battery to a power supply. Therefore, the present invention provides the advantages of ease in use, protection of cellular phone, and less cost to users. It is needs to be noticed here that even though a cellular phone is herein taken as an example of the electrical device, the battery of the present invention can be also applied in other electrical devices.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A battery, comprising:
a battery cell storing electrical energy;
a housing enclosing the battery cell, and the housing having a socket formed thereon; and
a control circuit for controlling the battery, the control circuit comprising a charging circuit for electrically coupled the socket to the battery cell;
wherein when the socket is coupled to a power supply, the battery cell is charged through the charging circuit.

2. The battery according to claim 1, wherein the housing comprises a bottom and the socket is disposed on the bottom of the housing so that while the battery is installed in an electrical device, the socket is exposed out of the electrical device in order to allow the power supply to be directly coupled to the socket.

3. The battery according to claim 1, wherein the control circuit further comprises a charge protecting circuit for preventing the battery from over-charging, the charge protecting circuit being electrically connected to the charging circuit and the battery cell.

4. The battery according to claim 1, wherein the charging circuit is disposed on an interior of the housing.

5. The battery according to claim 1, wherein the housing of the battery further comprises an indicator to indicate a power level of the battery.

6. The battery according to claim 5, wherein the indicator is a light-emitting diode.

7. The battery according to claim 1, the housing of the battery having an exposing face and the socket being deposed on the exposing face, wherein while the battery is installed in an electrical device, the socket is exposed out of the electrical device so that the power supply can be electrically connected to the socket.

8. The battery according to claim 1, wherein the housing of the battery has a conjunction face and a terminal on the conjunction face so that while the battery is installed in a main body of an electrical device, the conjunction face is covered by the electrical device and the terminal is electrically connected to the electrical device.

9. A battery, comprising:
an exposing face and a conjunction face, wherein while the battery is installed in an electrical device, the exposing face is exposed and the conjunction face is covered by the electrical device;
a terminal disposed on the conjunction face; and
a socket disposed on the exposing face;
wherein when the battery is attached onto the electrical device, the terminal is electrically connected to the electrical device, and the socket is exposed for electrically connected to a power supply.

10. An electrical device, comprising:
a main body; and
a battery installed to the main body, comprising:
a battery cell for storing electrical energy;
a housing for enclosing the battery cell, the housing having a socket formed thereon; and
a control circuit for controlling the battery, wherein the control circuit includes a charging circuit for electrically coupled the socket to the battery cell;
wherein when the socket is electrically connected to a power supply, the battery cell is charged through the charging circuit.

11. The electrical device according to claim 10, wherein the housing comprises a bottom and the socket is disposed on the bottom of the housing so that while the battery is installed in an electrical device, the socket is exposed out of the electrical device in order to allow the power supply to be directly coupled to the socket.

12. The electrical device according to claim 10, wherein the control circuit further comprises a charge protecting circuit for preventing the battery from over-charging, the charge protecting circuit being electrically connected to the charging circuit and the battery cell.

13. The electrical device according to claim 10, wherein the charging circuit is disposed on an interior of the housing.

14. The electrical device according to claim 10, wherein the housing of the battery further comprises an indicator to indicate a power level of the battery.

15. The electrical device according to claim 14, wherein the indicator is a light-emitting diode.

16. An electrical device, comprising:
a main body; and
a battery with a charging circuit installed on the main body, the battery comprising:
an exposing face and a conjunction face, wherein while the battery is installed in an electrical device, the exposing face is exposed and the conjunction face is covered by the electrical device;
a terminal disposed on the conjunction face; and
a socket disposed on the exposing face;
wherein while the battery is installed in the electrical device, the terminal is electrically connected to the electrical device, and the socket is exposed for electrically connected to a power supply.

17. The electrical device according to claim 16, wherein the electrical device has a surrounding flange surrounding a receiving cavity for the battery, and the surrounding flange comprises an opening exposing the socket while the battery is disposed in the receiving cavity.
